(19) United States
(12) Patent Application Publication
(10) Pub. No.: US 2002/0143564 A1
(43) Pub. Date: Oct. 3, 2002

(54) Website for household inventory and maintenance with reminder system and method

(76) Inventors: Brett M. Webb, Meridian, ID (US); David L. Lanning, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/825,592

(22) Filed: Apr. 3, 2001

(51) Int. Cl. G06F 17/60

(52) U.S. Cl. 705/1; 705/29

(57) ABSTRACT

A method of home maintenance comprises tracking a household inventory of items and related maintenance tasks for a user in a calendaring system and inventory system. The method includes notifying the user with a reminder from a home maintenance web site with the reminder including a notice to perform a maintenance task on an item of the household inventory and including a network link to the home maintenance web site. A computer-based home maintenance system comprises a user interface, a home maintenance website, a maintenance notification, and a network communication link permitting communication between the user interface and the home maintenance web site. The notification is viewable on the user interface that is generated by the home maintenance web site and includes a reminder to perform a maintenance job.

### FIELD OF THE INVENTION

The present invention relates generally to computer network-based information systems and in particular to a computer network-based system and method for tracking and supporting home maintenance.

### BACKGROUND OF THE INVENTION

Entropy is a powerful force. Perhaps no one knows this more than a home owner. Operating a home requires an endless cycle of cleaning, maintenance, repair, and at one time or another, replacing virtually every part of the home, inside and outside. Several obstacles challenge the average homeowner. They must remember to do the maintenance, know how to do it, find the right instructions, know what tools to use and get the parts for repair or replacement. Moreover, a home is unlike other possessions such as an automobile that can be serviced at a single location such as auto dealer. A home includes items made by a hundred different manufacturers, sold by dozens of retailers, all of which were installed or repaired by many different contractors.

For newer homes, some of the necessary information for maintaining items in the home, such as appliances, is found in dozens of different product manuals with a separate manual for each item in the house. Many items in the house have sparse documentation. Quite commonly, owners of older homes may receive a house that has no documentation on the house or items in the house. While there are books available with maintenance information that can assist in this process, the homeowner must seek out this information and assimilate it into a plan of action for maintaining their home. This process can involve simply trying to remember to do the maintenance task, working from a checklists or maintenance books, or working from the product manuals themselves.

Faced with the daunting task of comprehensive home maintenance, most homeowners simply wait until something breaks and then call a repairperson. However, this can be quite unsatisfying for anyone who cares to maintain their home in a consistent working order, or make improvements along the way. Properly maintaining a home reduces long term energy costs, adds value to the home, makes the home more comfortable, and engenders a sense of value and enjoyment in home ownership.

Recent innovations in computer communications offer a glimmer of hope in remembering important dates with the use of computerized calendars, including network based calendars. Moreover, there are dozens of reminder services to assist computer users in remembering important dates. However, most of these calendars and reminder services are generic, including no specific information on the item you are calendaring and including little or no information on how to complete the task the user has in mind. Accordingly, while these calendars are computerized, they still leave much to be desired in terms of actually completing a scheduled task. In this sense, these computerized calendars offer little more than desktop paper calendars.

### SUMMARY OF THE INVENTION

A method of home maintenance comprises tracking a household inventory of items and related maintenance tasks for a user. The method includes notifying the user with a reminder from a home maintenance web site with the reminder including a notice to perform a maintenance task on an item of the household inventory and including a network link to the home maintenance web site.

A computer-based home maintenance system comprises a user interface, a home maintenance website, a maintenance notification, and a network communication link permitting communication between the user interface and the home maintenance web site. The notification is viewable on the user interface that is generated by the home maintenance web site and includes a reminder to perform a maintenance task.

### BRIEF DESCRIPTION OF THE DRAWINGS

FIG. 1 is a block diagram of a home maintenance system of the present invention.

FIG. 2 is a block diagram of a database system of a home maintenance system of the present invention.

FIG. 3 is an illustration of a web site of a home maintenance system of the present invention.

FIG. 4 is a flow diagram of a method of home maintenance using the home maintenance web site of one embodiment of the system and method of the present invention.

FIG. 5 is a flow diagram of a method of home maintenance provided by a home maintenance web site of one embodiment of the system and method of the present invention.

FIG. 6 is a block diagram of a maintenance reminder of a home maintenance system of the present invention.

FIG. 7 is a block diagram of a maintenance job ticket of a home maintenance system of the present invention.

FIG. 8 is a flow diagram of an alternate method of home maintenance provided by a home maintenance web site of one embodiment of the system and method of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A home maintenance system and method of the present invention enables homeowners to track an entire inventory of household items for maintaining the home. Users can perform maintenance tasks using comprehensive information from a web site of the system and method of the present invention about items from both retailers and manufacturers that is both specific and personal to the user's items. Items include everything that is in the house (e.g. furniture), that structurally forms part of the house (e.g. attic, roof, windows, floors, walls, siding, paint) and/or operates in the house (e.g. furnace, appliances). The system and method operates a reminder system to alert the user to perform the maintenance task while providing access to tools, parts, advice, and service personnel, as necessary. The user is reminded by an email, popup window notification, or a calendar alert, all of which are provided in the system and method of the present invention.

In addition, a registered user inventory of household items registered with the web site and maintenance history is conveyed to manufacturers and retailers to allow the manufacturers and retailers to better supply information, track product performance and history, and to provide after-the-sales service including product replacement. The system and method encourages and supports comprehensive home maintenance for both novice and experienced homeowners, grants retailers and manufacturers a wider audience, and supplies the owner/operator of the web site with income while providing a needed service.

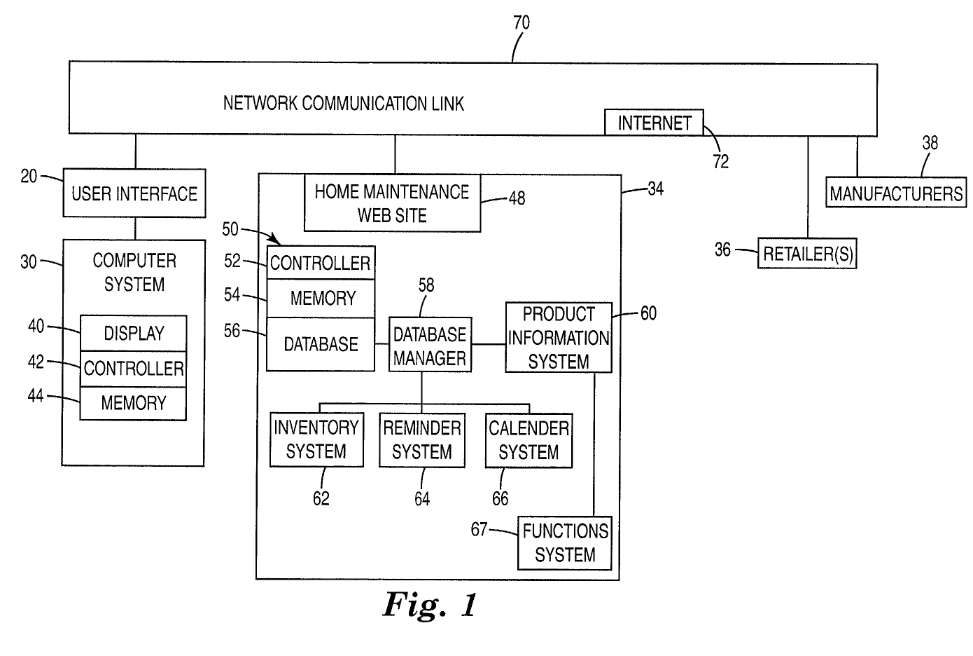

FIG. 1 illustrates an exemplary embodiment of a home maintenance system and method of the present invention generally at 10. Components of the home maintenance method and system of the present invention can be implemented in hardware via a microprocessor, programmable logic, or state machine, in firmware, or in software within a given device. In one aspect, at least a portion of the software programming is web-based and written in HTML and JAVA programming languages, including links to graphical user interfaces for data collection, such as a windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term computer-readable medium as used herein is defined to include any kind of memory, volatile or non-volatile (e.g., floppy disks, hard disks, CD-ROMs, flash memory, read-only memory (ROM), and random access memory (RAM)).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

Home maintenance system 10 includes user interface 20, computer system 30, home maintenance service provider 34, retailer(s) 36, manufacturer(s) 38. Computer systems 30 further includes display 40, controller 42, and memory 44. Home maintenance service provider 34 includes web site 48, supported by system 50 having controller 52, memory 54, database system 56 with database manager 58. System 50 also includes product information system 60, inventory system 62, reminder system 64, calendar system 66, and functions system 67. Home maintenance system 10 also includes network communication link 70.

Home maintenance system 10 includes user interface 20 (e.g., a graphical user interface) operating on computer system 30 to permit access to home maintenance web site 48. Both user interface 20 and home maintenance web site 48 can be implemented in hardware via a microprocessor, programmable logic device, or state machine, and firmware, or in software within a given device. In one aspect, at least a portion of the software programming is written in Java programming language, and user interface 20 communicates with home maintenance web site 48 via network communication link 70 using a communication bus protocol. For example, the present invention optionally can use a TCP/IP protocol suite for data transport. In another aspect, the present invention does not use a TCP/IP protocol suite for data transcript. Other programming languages and communication bus protocols suitable for use with home maintenance web site 48 and system 10 will be apparent to those skilled in the art.

Computer system 30 preferably is a microprocessor based desktop computing device but optionally can be embodied in a handheld and/or wireless mobile computing device such as a personal digital assistant, or smart mobile phone.

System 50 of home maintenance web site 48 uses controller 52 that includes hardware, software, firmware or combination of these. In one preferred embodiment controller 52 includes a computer server or other microprocessor based system capable of performing a sequence and logic operation and including memory 54 for storing information. In addition, controller 52 can include a microprocessor embedded systems/appliance incorporating tailored appliance hardware and/or dedicated single purpose hardware. Controller 42 of computer system 30 has substantially the same features as controller 52.

Retailer(s) 36 comprise retailers that have an exclusive fee-for-association contractual relationship with home maintenance service provider 34. In this relationship, retailer 36 sells products that relate to the user's inventory of household items and/or that relate to maintenance tasks that the user will perform. This exclusive arrangement insures that users accessing home maintenance web site 48 will be exposed to products from retailer 36 when the user performs maintenance on items that are related to products sold by retailer 36. Retailer(s) 36 preferably has its own web site for expediting sale of their products to users via home maintenance web site 48. Manufacturer(s) 36 comprise product manufacturers that sell products through retailer(s) 36 and which preferably have their own web site for enhancing marketing of their products and for providing and receiving information about their products.

Calendar system 66 of web site 48 includes a personal calendar that is a web-centric type calendar accessible through network communication link 70 for tracking inventory items and maintenance tasks that are personal to the user. Similarly, database system 56 is a web-centric type database for tracking inventory items and maintenance tasks personal to the user in association with calendar 66.

Network communication link 70, as used herein, includes an Internet communication link, an intranet communication link, or similar high-speed communication link. In one preferred embodiment, network communication link 60 includes an Internet communication link 72. Network communication link 70 permits communication between user interface 20, home maintenance web site 48, retailers 36 and manufacturers 38.

As will be explained in greater detail later in this application, by using system 10, the user may receive a pop-up window or email notification on user interface 20 (on display 40 of computer system 30) of upcoming maintenance task for inventory items, as well as a job ticket specifying how to perform the maintenance task.

Each of product information system 60, inventory system 62, reminder system 64, calendar system 66, and functions system 67 is supported by and operates with controller 52 and database manager 58 to operate web site 48, particularly including the entry, retrieval, manipulation, and use of household item information in and out of database system 56.

Product information system 60 tracks, stores and directs transfer of comprehensive product information between a user, web site 48, retailer(s) 36 and/or manufacturer(s) 38. For example, using database system 56 via database manager 58, product information system 60 conveys to retailer(s) 36 and manufacturer(s) 38 information gleaned from the users inventory of household items, and including all related maintenance tasks and performance history. Likewise, retailer(s) 36 and manufacturer(s) 38 make this information available to user through web site 48.

Inventory system 62 governs entry of and maintains data regarding the entire household inventory including comprehensive data regarding each item such as the brand, model, quantity etc. of each item. Functions system 67 governs entry and retrieval of data regarding at least one maintenance function for each item such as maintenance, troubleshooting, replacement, complaints, in-service etc.. Calendar system 66 governs display and operation of a calendar on home maintenance web site 48 to allow a user to track maintenance deadlines for each item in the household inventory and cooperates with reminder system 64 to remind users of upcoming, current, and past maintenance tasks for each household item. Calendar system 66 provides reminders through a calendar accessible via home maintenance web site 48 or printable on paper, as well as through email and popup windows.

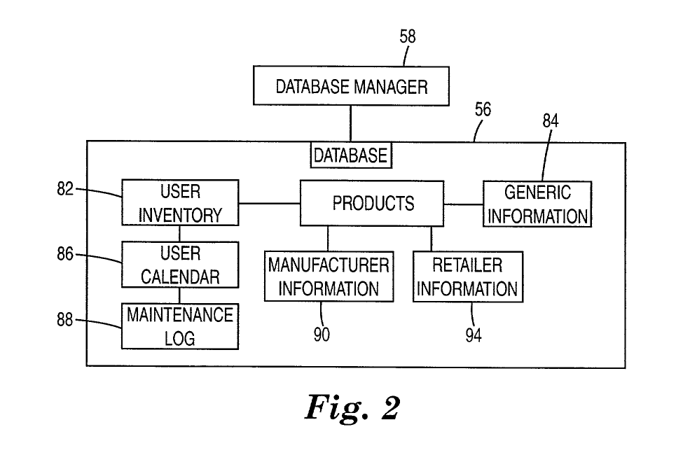

FIG. 2 illustrates database system 56 and database manager 58. Database system 56 further includes following database components: products database 80; user inventory 82; generic product information 84; user calendar 86; maintenance log 88; manufacturer information 90 (including specific product information); and retailer information 94.

These components comprise separate databases linked together into one operating database or can comprise a single comprehensive database with each of the named components identifying select portions of the single comprehensive database. Products database 80 stores comprehensive information about all products sold by retailers 36 and manufacturers 38 that relate to homes. This information includes both generic information 84 about a product (e.g., how to drain a water heater) and manufacturer information 90 that includes specific information about each model or brand (e.g, maintenance instructions for a particular brand of water heater). In addition, products database 80 incorporates retailer information 94 that describes detailed information on all products sold and/or serviced by retailer 36.

User inventory 82 includes a comprehensive listing of all items entered into database system 56 by the user for tracking home maintenance. User inventory 82 is linked to products database 80 so that generic product information 84, manufacturer product information 90, and retailer product information 94 are associated with each product that is registered as an item in the user's inventory. User calendar 86 includes a calendar database for associating each item in user inventory 82 and its associated maintenance tasks with a due date for performing the maintenance tasks. Finally, maintenance log 88 records the maintenance history of each item. Of course, like other information in database system 56, information in maintenance log 88 is conveyed to retailer(s) 36 and manufacturer(s) 38 for improving their products, sales and service.

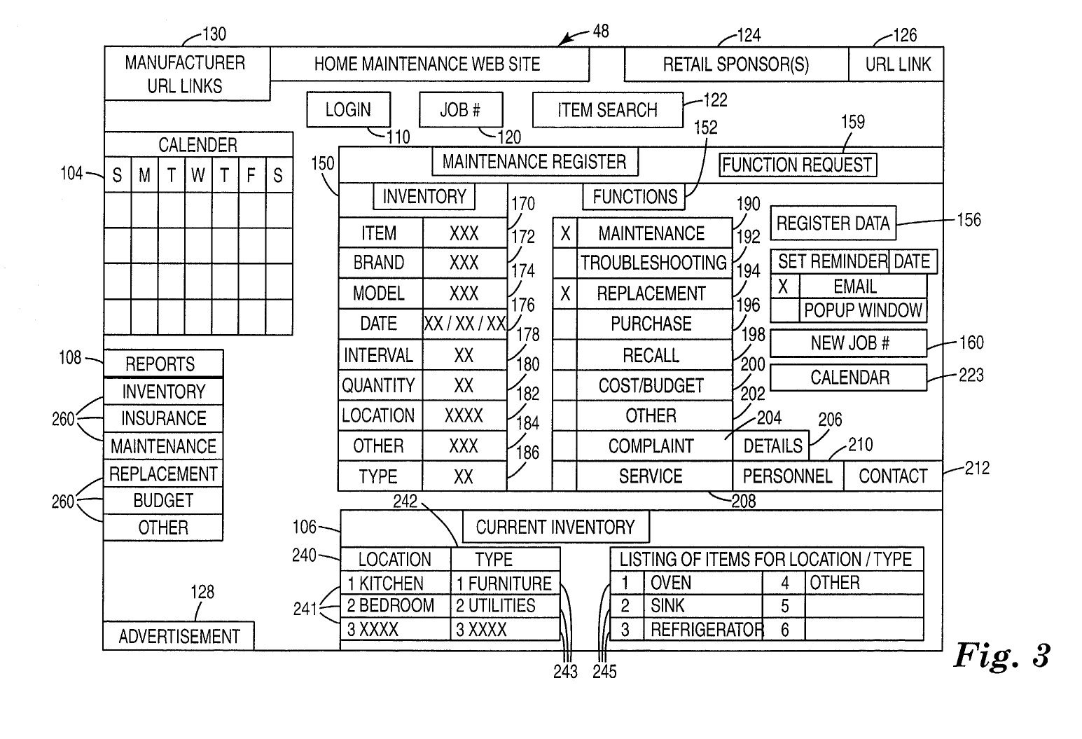

All components of database system 56 use database technology and protocols well-known to those skilled in the art. Database manager 58 acts as a controller over database system 56 regulating the inclusion, exclusion, selection, and modification of data in those databases including selection and modification of the content, components, and style of each database. Accordingly, database manager 58 (with the support of controller 52) regulates all communication in and out of database system 56, including each of the individual databases 80-94 shown in FIG. 3. Of course database manager 58 selectively controls all of the database components, only a single database, or select combinations of databases 80-94, all selected upon the discretion of the owner/operator of home maintenance web site 48.

In alternate database system, manufacturer information 90 is maintained in a database operated by manufacturer(s) 38 and retailer information 94 is maintained in a database operated by retailer(s) 36. In this example, retailer(s) 36 and manufacturer(s) 38 provide limited access to their databases by web site 48 for user information requests regarding maintenance, warranties, etc. where web site 48 acts as the point of contact for the user. This arrangement would drastically reduce the amount of information stored in database system 56 that is not personal to the users.

FIG. 3 illustrates home maintenance web site 48 which includes maintenance register 102, personal calendar 104, current inventory 106, reports module 108, and login function 110. Web site 48 further includes job number function 120, items search 122, retail sponsor 124 with URL link 126, advertisement 128, and manufacturer URL links 130.

Maintenance register 102 is used in at least two ways. First, maintenance register 102 facilitates the entry of a user's inventory of household items into database system 56. Second, maintenance register 102 operates as a lookup tool in which the user can enter an item and then lookup generic or specific product information about the item without creating a registered inventory. Maintenance register 102 includes inventory register 150, functions register 152, register data function 156, reminder activation function 158, new job number 160.

Inventory register 150 facilitates entry of specific information about an item, while functions register 152 associates a number of maintenance functions with the item. Inventory register 150 includes item 170, brand 172, model 174, date 176, interval 178, quantity 180, location 182, other 184, and type 186. Each of these data are entered by the user or selected from drop down menus or lists provided by web site 48. Item 170 specifies the product to be maintained, which can be further identified by entering a brand and model into brand and model fields 174. Date 176 specifies the date of purchase or date of first use for the item while interval 178 optionally specifies a desired frequency or interval of maintenance. For example, interval 178 optionally is the life expectancy of an item, and near the end of its life expectancy home maintenance web site 48 sends the user a reminder to inspect or replace the item.

Quantity 180 specifies the quantity of that item 170 in the household, while location 182 specifies the location of item 170 in the household (e.g. family room, garage, basement, bedroom) so that each item can be uniquely identified by its location. Other 184 further specifies other information about the item such as a serial number and type 186 further specifies the type of item, such as furniture, utilities, appliances, etc.

Functions register 152 further includes specific maintenance functions including normal maintenance 190, troubleshooting 182, replacement 194, purchase 196, recall 198, cost/budget 200, other 202, complaint 204 with details 206, and service 208 with personnel 210 and contacts 212. Functions register 152 allows selection of one or more maintenance functions of web site 48 to be associated with each item in the household inventory. Typically, the functions are selected for each item at the time the item is entered into inventory register 150. Information defining each function is drawn from database system 56 (via database manager 58), and in particular, from products database 80. Accordingly, information about the item in database system 56 for each function is automatically associated with the item upon selection of the function in functions register 152.

Normal maintenance 190 specifies a set of maintenance tasks for that item and a maintenance schedule associated with that set of maintenance tasks. Troubleshooting 182 specifies instructions and data for solving problems related to item 170 while replacement 194 specifies how and when to replace item 170 along with a suggested replacement item which is available from retailer(s) 36. When a user considers a replacement purchase, replacement 194 also offers the user information on brands, models, life expectancy, problems, warranties, prices etc. (from products database 80) as well as URL links to retailer(s) 36 that sell the product.

Purchase 196 specifies a product available for purchase from retailer 36 and manufacturer 38 while recall 198 specifies any relevant recall information about item 170 that is specific to item 170 from products database 80. Web site 48, using information from manufacturer(s) 38, sends a reminder to the user regarding recalls, product warnings, improvements, and remedies available to the user. Cost/budget 200 specifies a price associated with purchase of item 170 or a cost associated with performing normal maintenance 190, while other 202 permits the use of a custom function. Complaint 204 permits the logging of a complaint for item 170 with details 206, which will be stored in database system 56 and then conveyed to retailer 36 and manufacturer 38. Web site 48, retailers 36 and manufacturers 38 can respond to a complaint electronically through email, over the phone, or in person. Service 208 specifies or requests a service provider that can service item 170 with the required maintenance including suggested service personnel 210, while contact 212 specifies contact information necessary to communicate with personnel 210.

Register data function 156 causes any data entered into inventory register 150 and functions register 152 to be stored in database system 56. Reminder activation function 158 is optionally selected to initiate a reminder to be sent to the user in association with calendar 104 for notifying the user of a maintenance task to be performed for a specific item. Finally, new job number 160 allows an alphanumeric code to be associated with a maintenance task(s) for an item.

Reminder activation function 158 further includes set reminder function 220, with dates 222, calendar option 223, e-mail option 224 and pop-up window option 226. Date 222 specifies the requested date for the reminder, which optionally can be filled in by web site from maintenance information about item 170 from database system 56. Calendar reminder option 223 triggers an audiovisual calendar alert that appears in calendar 104 of web site 48. In addition to, or in place of a calendar reminder, email option 224 authorizes that an electronic mail notification be sent to the user specifying an item and a related maintenance task to be performed. Popup window option 226 makes the same notification as email option 224 except that the reminder message is delivered in a pop up window. Upon activation, set reminder function 220 initiates the request for a reminder and the method of reminder (calendar, email and/or popup window).

Current inventory 106 displays a current inventory of household items for a user registered at home maintenance web site 48. Current inventory 106 includes location register 240 with locations 241, type register 242 with types 243, and display register 244 with items 245. Location register 240 lists a location 241 of each item within the household while type register 242 lists the type 243 of each item so that an item can be sorted by location and/or type and can be uniquely identified by location and/or type. Display register 244 displays items 245 that are associated with a selected type or location from location register 240 and type register 242.

Reports function 108 further includes multiple report options 260 (inventory, insurance, maintenance, replacement, budget, and other). Reports function 108 permits a user to print or display reports regarding items 170 with information grouped for a particular purpose, such as insurance or maintenance.

Finally, login function 110 permits the user to login with a user name and password for private access to a confidential user account with home maintenance web site 48. Job number 120 permits a registered user to obtain inventory and maintenance information on a previously registered item and associated maintenance task. Items search 122 permits the user to search for particular items in the user inventory or in database system 56. Retail sponsor 124 identifies a retailer that purchases fee-for-display space on home maintenance web site 48 with URL link 126 to encourage the user to access the retailers web site. Similarly, manufacturer URL link 130 encourages users to access products information from manufacturers directly when appropriate. Finally, advertisement 128 includes a retailer or manufacturer that advertises a product or service to the user on home maintenance web site 48 under a fee-for-display contractual relationship with home maintenance web site 48.

Each of the components of home maintenance web site 48 can be incorporated into a single web page as shown in FIG. 3, or alternatively, divided into multiple Web pages with each web page display in operating one or more web site components.

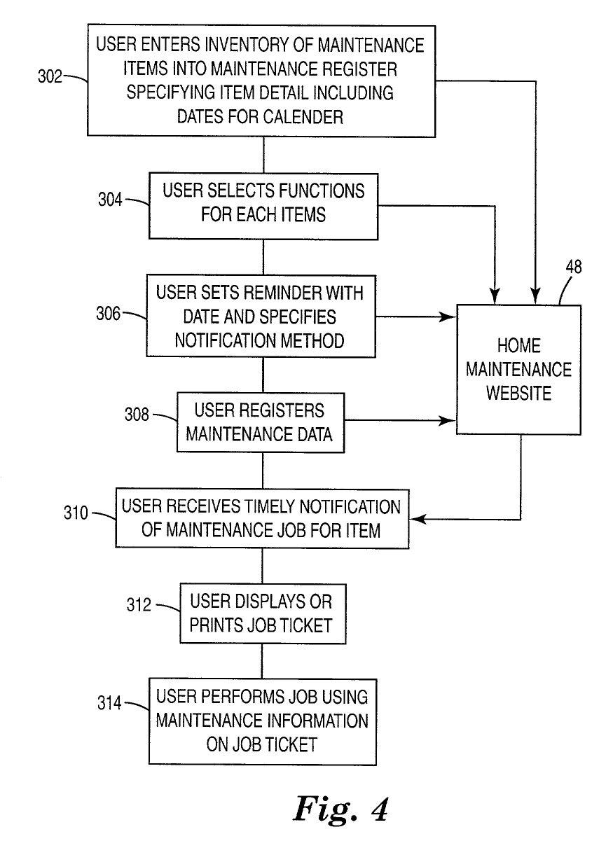

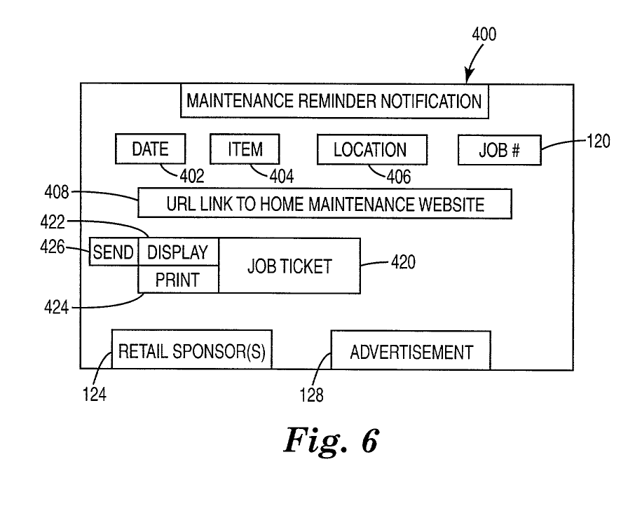

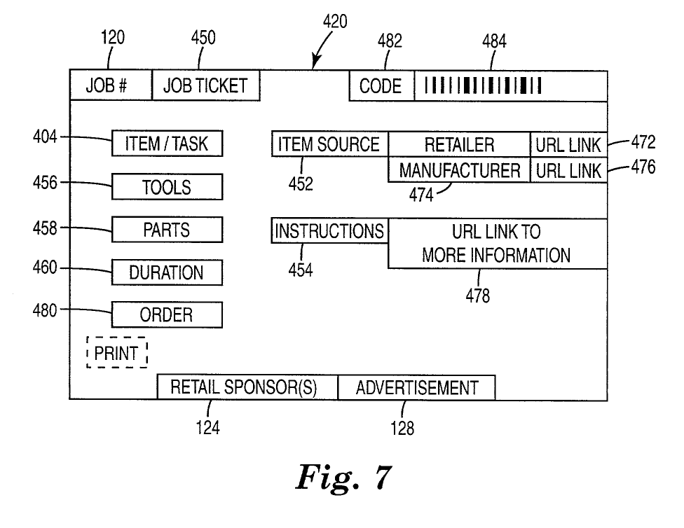

FIG. 4 illustrates at least one aspect of the home maintenance method 300 of the present invention from the perspective of a user. In this method, the user first enters an inventory of household items into maintenance register 102 of home maintenance web site 48 specifying details and including dates for calendar 104 of home maintenance web site 48 (step 302). Next, the user selects maintenance functions from functions register 152 of home maintenance web site 48 for each item 170 (step 304). The user then sets a reminder with reminder activation function 220 that specifies a notification method (calendar 223, e-mail 224 or pop-up window 226) (step 306). After identifying item 170 and selecting maintenance functions with a reminder date, the user activates register data function 156 to request entry of this information into database system 56 (step 308). Next, the user receives a timely notification reminder of a maintenance job for the specified item including a job ticket (step 310). The user activates a display for the job ticket or prints the job ticket (step 312), and then performs the maintenance task using maintenance information made available on job ticket (step 314). The job ticket will be described in further detail in association with FIGS. 6 and 7.

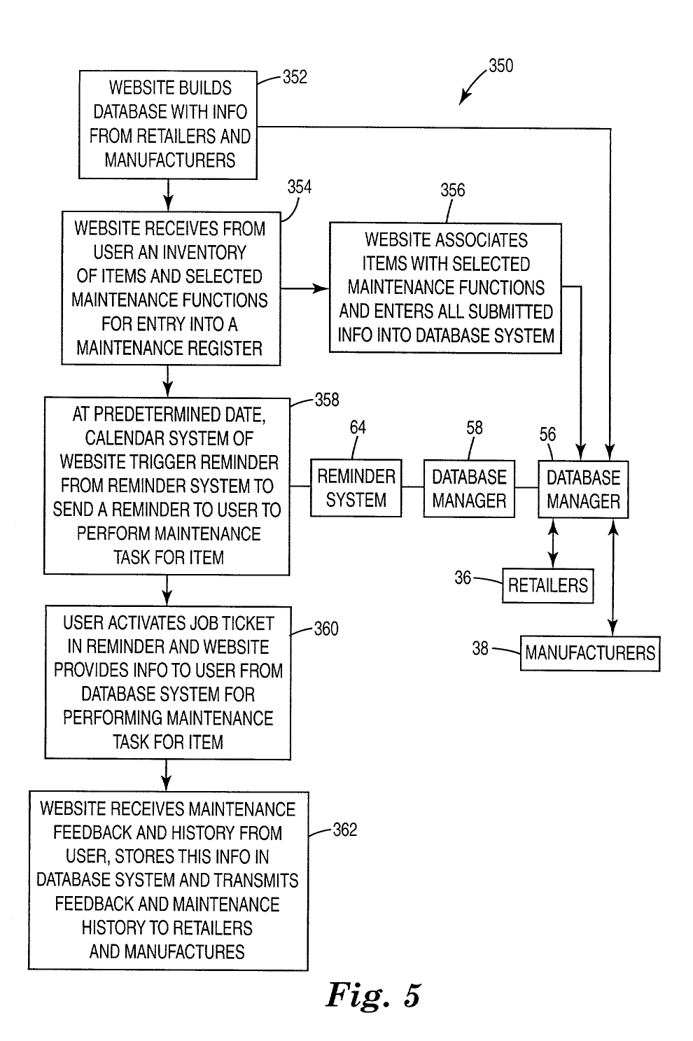

FIG. 5 illustrates another aspect of the home maintenance method 350 of the present invention from the perspective of home maintenance web site 48, retailers 36 and manufacturers 38. In a first step (352), home maintenance web site 48 builds database system 56 with information from retailers 36 and manufacturers 38. In particular, web site 48 builds, maintains and operates database system 56 with a vast array of information about home products in products database 80, drawing on generic product information 94, as well as more specific manufacturer and retailer information 90,94. As part of constructing database system 56, home maintenance web site 48 forges relationships with retailer(s) 36 and manufacturer(s) 38 to receive product information from retailer(s) 36 and manufacturer(s) 38 to build database system 56, and for transmitting consumer complaints, requests, product performance and maintenance history of products to retailer(s) 36 and manufacturer(s) 38. This information can be received and/or transmitted via network communication link 70 or through conventional communication techniques. With database system 56, web site 48 is prepared to receive and successfully support the entry, tracking, and maintenance support for an inventory of household items of a user.

Next, using maintenance register 102, home maintenance web site 48 receives into maintenance register 102 entry of an inventory of household items from a user via inventory register 150 along with requested maintenance functions from functions register 152 (step 354). Web site 48 stores this information into database system 56 via database manager 58 using database components 80-94 as necessary. Web site 48 operates database system 56 so that the selected maintenance functions are associated with item 170 and are linked to information in corresponding parts of database system 56 (step 356). For example, when a user selects normal maintenance 190 and troubleshooting 192 functions, item 170 is associated in database system 56 with manufacturer information 90 including specific product information 92 for that item as well as generic information 84. This associated information describes how to perform normal maintenance 190 and trouble shooting 192 for that item. Maintenance 190 and troubleshooting functions 192 also optionally are associated with retailer information 94 through products database 80 so that any required tools, parts, or materials available from retailer 36 are associated with item 170 in database system 56. Similarly, all of the other maintenance functions selected by user in functions register 152 are associated with item 170 in database system 56 so that any information in database system 56 relating to the selected function is supplied and reported to user for item 170. In addition, some of the maintenance functions of functions register 152 triggers a direct action a response by web site 48, retailer(s) 36 and/or manufacturer(s) 38 that is part of the selected function. For example, when a user selects complaint function 204, web site 48, retailer 36 and/or manufacturer 38 respond by contacting the user or initiating a customer satisfaction procedure (e.g. telephone follow-up, service call, etc.) for resolving the complaint with the user.

In the next step (358), home maintenance web site 48 reminds the user to perform the registered maintenance task for item 170. In particular, at a selected date, calendar system 66 of home maintenance web site 48 triggers reminder system 64 to send a reminder to the user to perform the maintenance task for item 170. Upon receiving the reminder, the user activates a job ticket in the reminder to obtain pertinent information from database system 56 of home maintenance web site 48 for performing the maintenance task (step 360).

Over time or immediately following the maintenance task, home maintenance web site 48 receives feedback from the user regarding the maintenance task and receives a performance history of item 170 (step 362). This information is stored in database system 56 and web site 48 transmits this maintenance feedback and performance history to retailers 36 and manufacturers 38. This last step forms a feedback mechanism so that information and products provided to the users are improved as quickly, and as often as possible. This feedback mechanism also permits the maintenance and performance history to be included in database system 56 to aid other consumers in problem solving, evaluating used and new products, and performing routine maintenance.

In step 360 of method 500, when web site 48 detects a due date for a maintenance function for item 170, controller 52 triggers reminder system 64 to notify the user with a reminder notification. FIG. 6 illustrates maintenance reminder notification 400, which includes date 402, item label 404, location/type 406, and job number 120. Notification 400 further includes URL link 408 to home maintenance web site 48, job ticket 420 with display function 422, print function 424, and send function 426. Notification 40 also includes retail sponsor 124 and advertisement 128.

Date 402 specifies the current date, item label 404 specifies item 170, and location/type 406 specifies the location 182 of item 170 and its type 186 in the user's home to further identify item 170. Job number 120 uniquely identifies one or more maintenance tasks associated with item 170. Notification 400 is sent to user either as a calendar alert, an electronic mail notification, or a popup window (e.g. pop-up calendar alert) from web site 48 depending upon the notification option (223, 224, or 226) that was previously selected during initial item registration in maintenance register 102. URL link 408 allows the user to proceed immediately to home maintenance web site 48. Otherwise, user uses job ticket 420 to access all information and/or services for job number 120. Job ticket 420 is displayed electronically by activating display function 422, printed onto paper by activating print function 424, and/or electronically sent to a personal computing device (e.g., personal digital assistant, handheld computer, etc.) by activating send function 426.

Reminder notification 400 received by the user includes job ticket 420. Upon activation of the display, print, and/or send functions 422,424,426 in notification 400, job ticket 420 is received by the user. FIG. 7 illustrates job ticket 420 with job ticket label 420, and job number 120. Job ticket 450 includes item label 404, item source 452 and instructions 454, as well as tools 456, parts 458, duration 460, cost 462, and order function 480. Item label 404 identifies inventory item 170, while item source 452 identifies one or more retail sources 470 and one or more manufacturer sources 474 as resources (e.g., parts, tools, advice, service, etc.) for assistance in completing job number 120 for item 170. Item source 452 further includes retailer URL link 472 and manufacturer URL link 476 for contacting retailer(s) 36 and/or manufacturer(s) 38. For example, when job ticket 420 is displayed electronically, URL links 472 and 476 can be activated to communicate with retailer(s) 36 and manufacturer(s) 38 via network communication link 70.

Instructions 454 of job ticket 420 specifies detailed instructions for performing the maintenance task for item 170 and job ticket 420 further includes URL link 478 for accessing home maintenance web site 48 to obtain more generic or specific product information from database system 56. Tools 456, parts 458, duration 460, and cost 462 respectively specify the tools and parts needed to perform the maintenance task for item 170 as well as the amount of time and cost of performing the maintenance task. Finally, job ticket 420 includes an optional print function 488 when job ticket 420 is displayed electronically, and includes code 482 with optional bar-code 484. Code 482 is used by retailer(s) 36 and manufacturer(s) 38 for uniquely identifying item 170 and job number 120 when working directly with the user. For example, order function 480 is available for user to order the suggested tools, parts or items from a retailer via web site 48. When that order is placed, code 482 is optionally used to instantly identify to retailer 36 (via database manager 58 and product database 80) which part, tool, or item is being ordered. Job ticket 420 also includes retail sponsor 124 and advertisement 128.

For example, a user that registered a furnace as item 170 in the maintenance register 102 at web site 48 would receive a timely reminder (perhaps monthly) to change the filter in the furnace. Job ticket 420 in reminder notification 400 would specify the time, tools, and parts (e.g. replacement filters) required along with a retailer/manufacturer URL link or order function 480 for purchasing the filters on-line or in person.

In an alternate embodiment, job ticket 420 optionally forms part of reminder notification 400 so that no separate steps are required to access job ticket 420. Rather, all of the information shown in FIG. 7 for job ticket 420 is included in and shown in reminder notification 400.

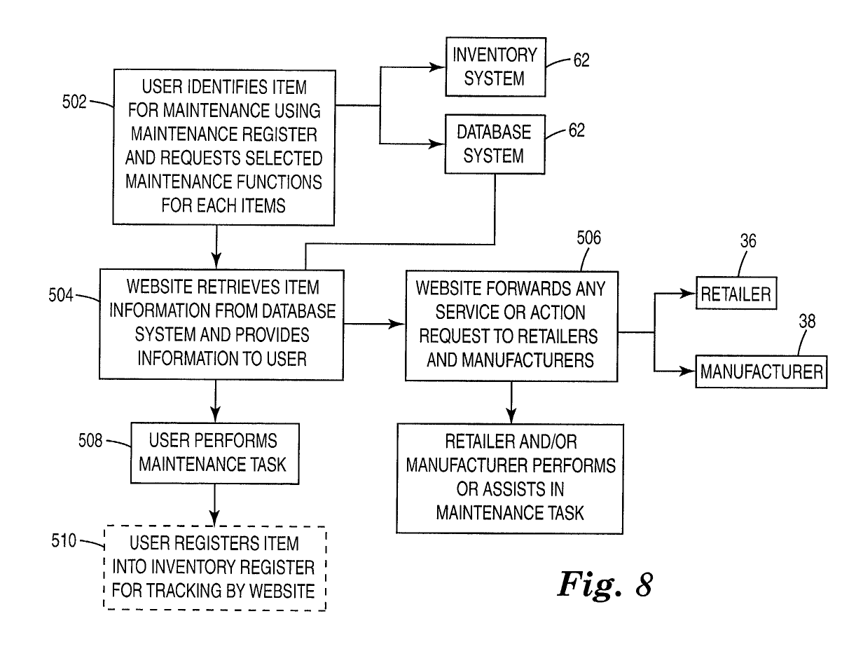

FIG. 8 illustrates an alternate home maintenance method 500 of the present invention. In this method, web site 48 acts a lookup table for obtaining information about a product without entering that product into the user's personal inventory and without web site 48 storing that item in database system 56. Instead, the user can simply access the product information in database system 56 or request goods or services from retailer(s) 36 and manufacturer(s) 38 via web site 48. In the first step (502) of this method, the user first enters a product into item 170 of inventory register 150 along with any other known identifying information into respective data fields (e.g., brand 172, model 174, etc). Next, the user selects a maintenance function such as recall function 198 or replacement function 194. Instead of registering the item in database system 56 (via register data function 156), the user activates function request 159 in maintenance register 102 of web site 48. In response, web site 48 retrieves the requested information from database system 56 and displays the requested information (both manufacturer information 90 or generic information 84) that is already stored in database system 56 for that item. Where other functions (e.g. service, complaint, recall) call for an action to be taken by retailer(s) 36 or manufacturer(s) 38, activating function request 159 triggers web site 48 to forward the request to retailer(s) 36 and manufacturer(s) 38 to supply a product, initiate a service call, or otherwise satisfy the user request with an action (step 506).

When retailer(s) 36 and manufacturer(s) 38 are not responding to a function request 159, then the user proceeds by performing the maintenance task for the item using the information provided by web site 48 (step 508). During or after this use of web site 48, the user optionally can register the data regarding item 170 in inventory register 150 of web site 48 for storage in database system 56 (step 510).

A home maintenance method and system of the present invention can readily be adapted and applied to a business building, or other structure that requires similar maintenance to a home. Retailer(s) 36 and manufacturer(s) 38 can modify or expand the information supplied to web site 48 for database system 56 to include commercial or non-home products, maintenance information, etc. Similarly, other products requiring maintenance such as an automobile can be maintained through a web site in a method and system of the present invention that is adapted to inventory auto items and auto maintenance

A home maintenance method and system of the present invention carries numerous advantageous features. First, the method and system operates a web site to carry out the primary functions of the method and system. The web site permits a user to create a comprehensive inventory of household items and acts as a tracking station for prompting and monitoring maintenance on the items. The inventory includes any and all items in the home that can be replaced or maintained. With information from retailers and manufacturers, all relevant product information for maintenance, repair, service and replacement is linked to the item. Accordingly, for each item and associated maintenance tasks, the web site notifies the user with a reminder (email, calendar, popup window, mail) when it is time to perform a maintenance task. Significantly, the web site also provides the user with a job ticket which includes all necessary information for performing the maintenance task. The job tickets specifies the time, tools, and parts needed along with detailed instructions for performing the maintenance. All of the tools and parts can be conveniently purchased from a retailer by activating a URL link to the retailer in the job ticket of the reminder. The web site also allows the user to enter a performance history of the item as it tracks maintenance tasks on the item. The web site uses this consumer experience information, along with information from retailers and manufacturers, to create a single forum for learning about product performance and obtaining product information. This forum helps consumers to better use and maintain their products, as well as evaluate which new product to buy. Retailers and manufacturers benefit by receiving product performance information while receiving additional exposure to the consumer with opportunities for service and sales. Finally, the operator of the web site of the home maintenance system and method of the present invention provides a long needed service while profiting from the contractual relationships with retailer(s) 36, manufacturer(s) 38, and even consumers, where appropriate.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of home maintenance comprising:
tracking a household inventory of items and related maintenance tasks for a user; and
notifying the user with a reminder from a home maintenance web site with the reminder including a notice to perform a maintenance task on an item of the household inventory and including a network link to the home maintenance web site.

2. The method of claim 1 wherein the tracking step further comprises:
displaying the inventory items and maintenance tasks at the home maintenance web site.

3. The method of claim 1 wherein the tracking step further comprises:
associating with the item at least one maintenance function of the web site including: maintenance; troubleshooting; replacement; purchase; recall; cost/budget; other; complaint; and service.

4. The method of claim 1 wherein the tracking step further comprises:
associating with each item at least one descriptor including: brand; model; date; interval; quantity; location; other; and type.

5. The method of claim 1 wherein the tracking step further comprises:
tracking the inventory of household items by location and type; and displaying the inventory on the home maintenance website.

6. The method of claim 1 and further comprising:
providing reports for the inventory of household items, reporting on one or more of inventory, insurance, maintenance, replacement, budget, and other.

7. The method as in claim 1, and further comprising:
identifying a set of maintenance information for performing the maintenance task including identification of tools, parts, and instructions for performing the maintenance task, a duration of the maintenance task, and a source of the item.

8. The method of claim 1 wherein the notifying step further comprises:
providing a network link to a manufacturer web site that produces the maintenance item and a network link to a retailer web site that sells the maintenance item.

9. The method of claim 1 wherein the notifying step further comprises:
delivering the reminder to the user as an electronic mail notification from the home maintenance service provider through the user interface.

10. The method of claim 1 wherein the notifying step further comprises:
delivering the reminder to the user as a pop-up window at the user interface.

11. A computer-based home maintenance system comprising:
a user interface;
a home maintenance website;
a notification viewable on the user interface that is generated by the home maintenance web site and that includes a reminder to perform a maintenance task; and
a network communication link permitting communication between the user interface and the home maintenance web site.

12. The system of claim 11 wherein the notification further comprises:
at least one of a calendar alert, an electronic mail message, and a desktop-based pop-up window, each listing the maintenance task.

13. The system of claim 11 wherein the notification further comprises:
a job ticket including a listing of an item requiring maintenance and information on how to complete the maintenance.

14. A computer-based electronic home maintenance reminder notification system comprising:
a home maintenance service provider;
a display window on a user interface listing a household item, a maintenance task, and a due date for performing the maintenance task; and
a message in the display window received from the home maintenance service provider at a point in time prior to the due date and that includes a network link to a home maintenance web site of the service provider and instructions for performing the maintenance task.

15. The system of claim 14 wherein the message further comprises:
at least one of an electronic mail message and a pop-up window message.

16. The system of claim 14 wherein the message further comprises:
a text message identifying tools and parts needed, detailed information on how to perform the maintenance task, and the network link comprising at least one uniform resource locator link to the home maintenance web site.

17. A method of home maintenance notification comprising:
tracking an inventory of household items for a user in a computer network-based tracking station; and
notifying the user at a point in time prior to a maintenance deadline with an electronic reminder from the tracking station with the reminder specifying a maintenance item and a maintenance task for that item.

18. A computer-readable medium having computer-executable instructions for performing a method of home maintenance, the method comprising:
tracking a household inventory of items and related maintenance tasks for a user; and
notifying the user with a reminder from a home maintenance web site with the reminder including a notice to perform a maintenance task on an item of the household inventory and including a network link to the home maintenance web site.

19. A method of providing home maintenance information and service comprising:
receiving at a web site a maintenance information request from a user for a household item; and
delivering from the web site to the user maintenance information for performing maintenance on the item wherein the maintenance information is specific to the brand of the item and obtained from at least one manufacturer.

20. A home maintenance web site comprising:
a database;
a graphical user interface including:
a maintenance registry for entering a inventory of household items for storage in the database;
a calendar for tracking maintenance tasks for the items;
a reminder system for notifying the user of a maintenance task on at least one of the household items; and
a controller for operating the graphical user interface, the database, and the reminder system.
